(19) United States
(12) Patent Application Publication
(10) Pub. No.: US 2024/0338614 A1
(43) Pub. Date: Oct. 10, 2024

(54) ACTIVITY TIME RESERVATION AND MANAGEMENT SYSTEM

(71) Applicant: GOLFdistrict Inc., McLean, VA (US)

(72) Inventors: Joshua Adam Segal, McLean, VA (US); Kevin Steven Kalner, San Diego, CA (US)

(21) Appl. No.: 18/631,883

(22) Filed: Apr. 10, 2024

Related U.S. Application Data
(60) Provisional application No. 63/600,873, filed on Nov. 20, 2023.
(60) Provisional application No. 63/458,401, filed on Apr. 10, 2023.

(51) Int. Cl. G06Q 10/02; G06Q 30/08

(52) U.S. Cl. CPC G06Q 10/02; G06Q 30/08

(57) ABSTRACT

Approaches presented herein relate to the reservation and management of activity times available to perform activities, such as tee times, or other items included in an inventory, which may be bought, sold, or offered for sale. The reserved times may be electronically monitored and managed, such as in a tee time sheet including tee time details, to complete requests by users to transact the tee times. Electronic tokens may be created for each reserved time. Transactions can include listing the reserved time for sale, purchasing a listed time, submitting an offer to buy unlisted time, purchasing an unlisted tee time, and delisting a time. Additional services, such as guarantees and upselling, may be offered to a user when requesting a transaction.

### CLAIM OF PRIORITY

This application claims the benefit of both U.S. Provisional Application No. 63/458,401 (Attorney Docket No. 782985.000001) titled “SYSTEM AND METHOD FOR BOOKING TOKENIZED TEE TIMES WHICH CREATES A SECONDARY MARKET REVENUE FOR GOLF COURSES,” filed Apr. 10, 2023 and U.S. Provisional Application No. 63/600,873 (Attorney Docket No. 782985.000002) titled “ACTIVITY TIME RESERVATION AND MANAGEMENT SYSTEM,” filed Oct. 20, 2023, the entire contents of which is incorporated herein by reference.

### FIELD OF THE DISCLOSURE

The present disclosure relates to managing and completing transactions associated with activity times.

### BACKGROUND

Electronic storefronts enable venue owners and inventory resellers, such as golf course clubs or golf course partners, to provide users with reservations that can be booked, including tee times. A user, for example a golfer, may log into a website that includes available reservations for a golf course, and then purchase a reservation for later use. Many industries, such as the golf course reservation industry do not have access to a system for users to view and purchase inventory from multiple venues at once. Additionally, users are not able to buy, sell, offer, or resell, inventory between themselves. Offering additional services, merchandise, or upselling opportunities, such as types of guarantees, with these transactions has also not been possible. As a result, the offerings available to users is significantly limited and the value of reservations is reduced due to at least risks of the reservation being missed or canceled.

### BRIEF DESCRIPTION OF THE DRAWINGS

Various embodiments in accordance with the present disclosure will be described with reference to the drawings, in which:

FIG. 1 illustrates an environment that can be used for reserving and managing activity times, in accordance with various embodiments;

FIGS. 2A-2F illustrate example displays for content associated with reservations, in accordance with various embodiments;

FIGS. 3A-3C illustrate example schematic representations of market transactions, in accordance with various embodiments;

FIG. 4 illustrates an example process for completing transactions associated with activity times, in accordance with various embodiments;

FIG. 5 illustrates an example process for making an unsolicited offer for activity times, in accordance with various embodiments;

FIG. 6 illustrates a logical arrangement of a set of general components of an example computing device, in accordance with various embodiments; and

FIG. 7 illustrates an environment in which various embodiments can be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Systems and methods in accordance with various embodiments of the present disclosure may overcome one or more of the foregoing or other deficiencies experienced in conventional approaches to managing and reserving inventories, such as tee times, and processing related transactions. In particular, various embodiments provide approaches to transacting, buying, selling, and making offers for items from an inventory, such as tee times or other electronic offerings, and completing related processes. The related processes may include updating inventory information, customer information, processing payments, and additional services. Systems and methods may improve the availability of inventory items to users and the ability to resell items owned by users. Additionally, reservation systems and methods described herein may improve the processing of payments and additional services related to the activity time transaction through a more efficient use of resources, such as networks, applications, and databases, without sacrificing processing capabilities and output quality. Additionally, the use of the reservation system may further improve the sale process by offering additionally purchasing opportunities. The additional purchase opportunities may include insurance, guarantees, merchandise, and upselling. In an embodiment, the reservation system may offer one or more types of insurance for the activity time, such as weather-based insurance or guarantees.

Some embodiments of the present disclosure may be able to reference the availability of an activity time, including information that may include the relevant course and specific time and date, such as to complete one or more transactions related to the activity time. Embodiments of the present disclosure may also update the availability of the activity time in one or more systems or databases after completing a transaction. The updated availability of the activity time may then be provided to users, such as through a client computing device.

Reservations for events or activities, such as tee times or concerts, can be bought and sold through electronic marketplaces. Users may browse the available reservations from an inventory to find their preferred selection and make a purchase, and therefore may receive ownership of the reservation. The owner can then use the reservation to attend the event and in some cases may transfer ownership to another. Often, the reservation may be wasted if the user cannot attend the event or the event is canceled, such as due to weather, inaccessibility to the venue, or the like. For example, if an event is canceled due to weather, the value of the reservation may be lost if the owner does not have a guarantee, such as insurance.

Approaches in accordance with various embodiments can use one or more systems to provide users, including at least venues and customers, additional options and flexibility with transactions available for reservations or other items. Inventories from multiple venues can be presented to users from an electronic source, such as a website or an application, where users can review listing information for items, such as prices and description. Descriptions relating to the specific items may include location, dates, times, price history, owner history, and other information. Additionally, users can request to perform transactions with the items, such as listing for sale, listing for auction, purchasing, submitting an offer, delisting an offer, or other suitable transactions. In some embodiments, transactions may be primary market transactions between a user or user representative and a commercial ticket owner, such as a golf club owner, venue owner, distributor, or e-commerce website, or the like. Primary market transactions may be offered by the systems using a third-party. In another embodiments, transactions may be secondary market transaction between two users or user representatives, such as two golfers or the like. Secondary market transactions may be offered by the systems using a third-party. When a transaction for items is requested, the availability to perform the transaction may be reviewed in order to confirm if the transaction can be completed. The availability may be determined using related data, such as the owner identification and the specific transactions that can be completed transactions. For transactions that can be completed, the descriptions and availability of the item can be updated to reflect the completed transaction. At least some of the updated information can then be made accessible to users. In some embodiments, electronic tokens may be created, such as by using blockchain technology, for each activity time. The electronic tokens may then be used to participate in the secondary market.

Accordingly, the reservation systems and methods described herein may enable benefits for providers, such as golf courses. The benefits may include at least one or more of as the generation of additional revenue, the reduction of costs, the improvement of customer service, and reduction or elimination of abandoned reservations. Additional revenue may be generated through the use of the marketplace and auctions. Costs may be reduced by automating the booking process and eliminating the need for manual processing. Customer service may be improved by providing a more convenient way for customers to book activity times or slots. Abandoned reservations, or no-shows, may be reduced or eliminated by requiring prepayment for reservations. Course access may be increased by providing a secondary market, which may allow both solicited and unsolicited offers, where users may obtain activity times that would otherwise be unavailable. One or more databases of inventory may be centralized by bringing together a number of Application Programming Interfaces (APIs) to allow users to use one system for activity time transactions. Customer flexibility may be increased by providing the opportunity to sell unused tee times to promote customers making increased commitments to tee times. New types of buyers may be introduced by providing a secondary market to create a new market of buyers and increased market participation, including buyers purchasing and selling large blocks of tee times.

In an example, a golfer may access an application though a computing device, such as a computer, to view available tee time slots for a variety of golf courses. In some embodiments, the application may include tee time slots for a single golf course, for partnered golf courses, golf courses located within a specified area, or some other combination. A number of details for each slot may be provided or displayed to the user, such as the location or locations, time or times, number of available golfers that may attend, and other information. More information related to tee time slots may be provided by the application. The golfer may select one or more tee time slots to request completion a transaction. The transaction may include any number or type of actions, such as buying, selling, making offers, delisting, auctioning, advertising, hiding, adding co-owners or attendees, and other transactions. Since some tee time slots may not be available for certain transactions, the availability status of the tee times can be checked. For example, if a tee time slot is not available for purchase, then a request to buy the tee time slot will not be completed. In some instances, the availability status may include information including current ownership, allowable transactions, and other information. Additional information can also be referenced to determine if a transaction can be completed, such whether the provided payment is acceptable. The tee time slots, details, availability, additional information, and any other information may be stored in one or more databases or other systems. In one embodiment, inventory of tee time slots and related information may be available from one or more tee time sheets. For example, tee time slots for one course may be available from one tee time sheet and tee time slots for another course are available from another tee time sheet. If the requested transaction is determined to be allowable, the requested transaction may be completed, and the availability status of the tee times may be updated. The new availability status may be referenced when additional transactions are requested to be completed. After completion, the information related to the tee time slot available to users, such as golfers, may be updated. The information may be updated based on one or more of the completed transaction, the updated availability status, time left until the tee time, and other factors.

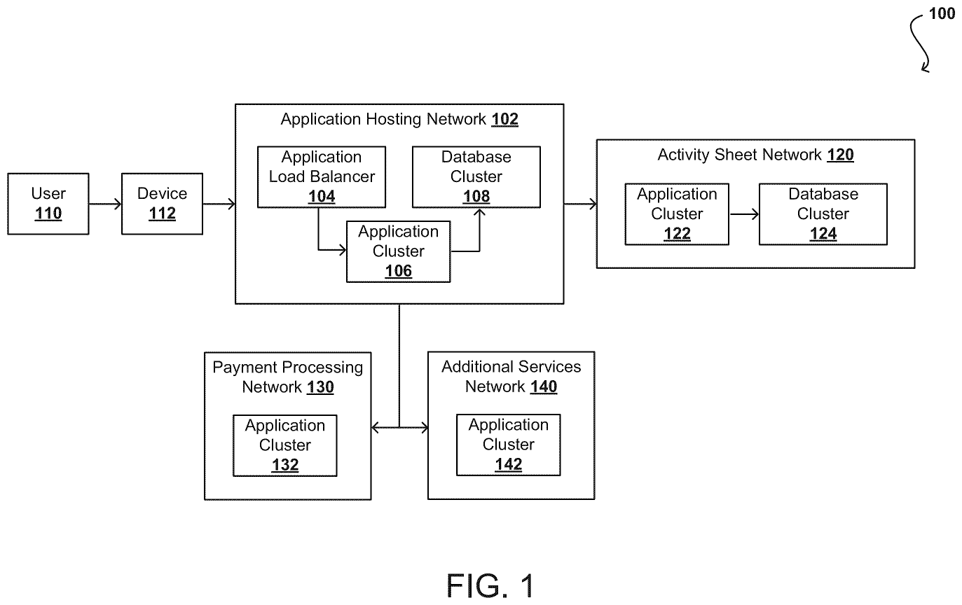

FIG. 1 illustrates components of an environment 100 that can be used to manage and facilitate activity time reservations and associated transactions in accordance with various embodiments. The environment 100 may include an application hosting network 102 that may include an application load balancer 104, an application cluster 106, and a database cluster 108 to host an application that may be accessed by a user 110 via one or more client computing devices 112. The application hosting network 102 may be one or more networks, or a system of interconnected electronic components, circuits, or other elements. The application load balancer 104 may be one or more load balancers, or a program to distribute traffic across nodes of an application or cluster. The application cluster 106 may be one or more applications, or a software packages that performs a specific function. The database cluster 108 may be one or more databases, or an structured information stored electronically in a computer system. The application hosting network 102 may include other elements to host and operate one or more applications.

The application hosting network 102 may communicate with an activity sheet network 120 to process reservations and manage activity times, such as tee times, for the application hosting network 102 and referenced from the activity sheet network 120. The activity sheet network 120 may include an activity sheet application cluster 122 and an activity sheet database cluster 124. The activity sheet application cluster 122 and the activity sheet database cluster 124 may process activity times as requested by the application hosting network 102. The activity sheet network 120 may include other elements to host and operate one or more applications relevant to processing activity times. The application hosting network 102 may have integrations with various activity sheet providers, such as tee sheet providers, which may be part of one or more activity sheet networks 120 or associate with activity sheet network 120 in one or more other ways. The activity sheet providers may offer varying levels of capabilities, such as retrieving course information, retrieving price classifications, such as public, member, and the like, retrieving activity times, retrieving customer information, booking activity times, retrieve bookings, and the like. The application hosting network 102 and the activity sheet providers may be integrated using one or more APIs. In some embodiments, since there exists varying level of capabilities, there may be no uniform method of calling the APIs. Therefore, each activity sheets API may be different from others. The application hosting network 102 may have to call one or more APIs and orchestrate the results to provide a uniform response to the applications.

In an embodiment, an activity sheet, such as a tee sheet, may be used as an inventory management system for an organization, such as a golf course. The tee sheet may be required to be updated if a reservation is purchased through a primary market or a secondary market. In an example, the prices, buyer, seller, and golfer names are entered into a tee sheet after a purchase. Programs or software may be used to integrate an application that transacts reservations with tec sheets, as the tee sheets and tee sheet providers may use different formats, APIs, request response, and the like.

The application hosting network 102 may communicate with a payment processing network 130 to process payments and financial transactions for the application hosting network 102. The payment processing network 130 may include a payment application cluster 132. In some embodiments the payment processing network 130 may include one or more databases or database clusters. The payment application cluster 132 may process payments as requested by the application hosting network 102. The payment processing network 130 may include other elements to host and operate one or more applications relevant to processing activity times, such as tee times. In one or more embodiments, a payment aggregator may be used with one or more of the application hosting network 102 and the payment processing network 130.

The application hosting network 102 may communicate with an additional services network 140 to provide additional services, such as insurance transactions, protections, guarantees, merchandise, or retail purchasing, and the like, for the application hosting network 102. The additional services network 140 may include an additional services application cluster 142. In some embodiments the additional services network 140 may include one or more databases or database clusters. The additional services cluster 142 may provide additional services, including processing insurance, protections, guarantees, merchandise, upselling, or other services related to an application as requested by the application hosting network 102. The additional services network 140 may include other elements to host and operate one or more applications relevant to providing additional services. In some embodiments, one or more of the activity sheet network 120, the payment processing network 130, and the additional services network 140 may be partially of entirely integrated with the application hosting network 102 or another network, or part of the application hosting network 102 or other networks.

In an example, the user 110 may use the device 112 connected to the application hosting network 102 to access an interface that allows the user 110 to view availability of activity time at one or more providers and to book activity time reservations. The interface may be received by a booking application to perform and verify the transaction and record information for the implementation of the transaction, such as to an activity sheet or a blockchain. The recording may enable proactive guaranteed scheduling among multiple parties. The user 110 may also use the device 112 connected to the application hosting network 102 to access an interface that allows the user 110 to trade activity times through a secondary market associated with environment 100 or a third-party system. The user 110 may complete trades or transactions of the activity times, such as buying, listing, selling, or auctioning. In an embodiment, the user 110 may buy, list, sell, or auction tokenized activity times, or transfer the tokenized activity times to individual wallets. For example, blockchain technology may be used to create tokens, such as a non-fungible token (NFT) for each activity time. The token may be created when the activity time is created, first booked, or other suitable condition. A tokenization system may create a for each tee time booked. The activity times may be restricted from being traded or transacted on one or more marketplaces, such as other than a primary marketplace or an authorized marketplace. For example, an activity sheet software provider API may prevent access to the activity times except for authorized entities.

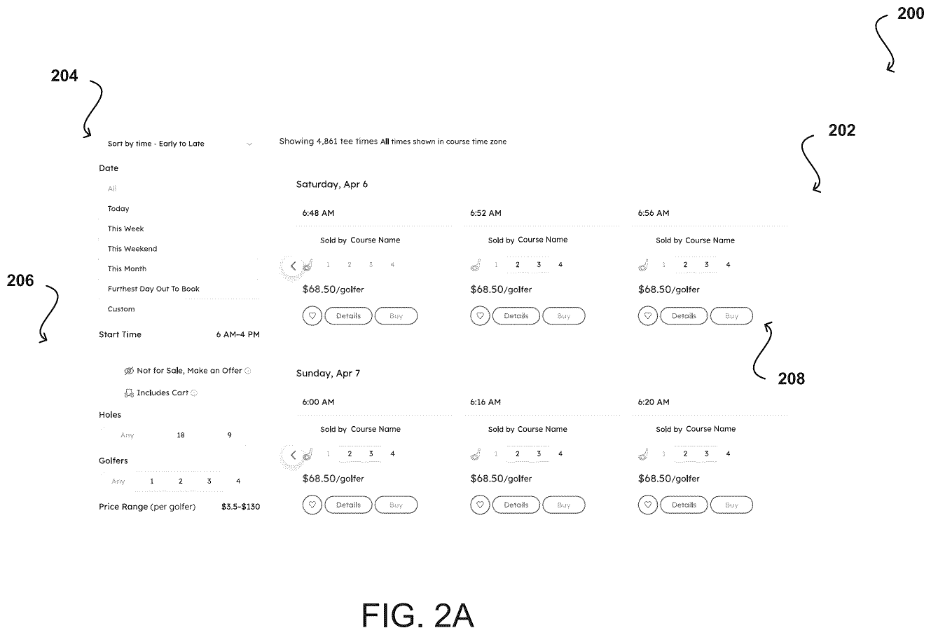

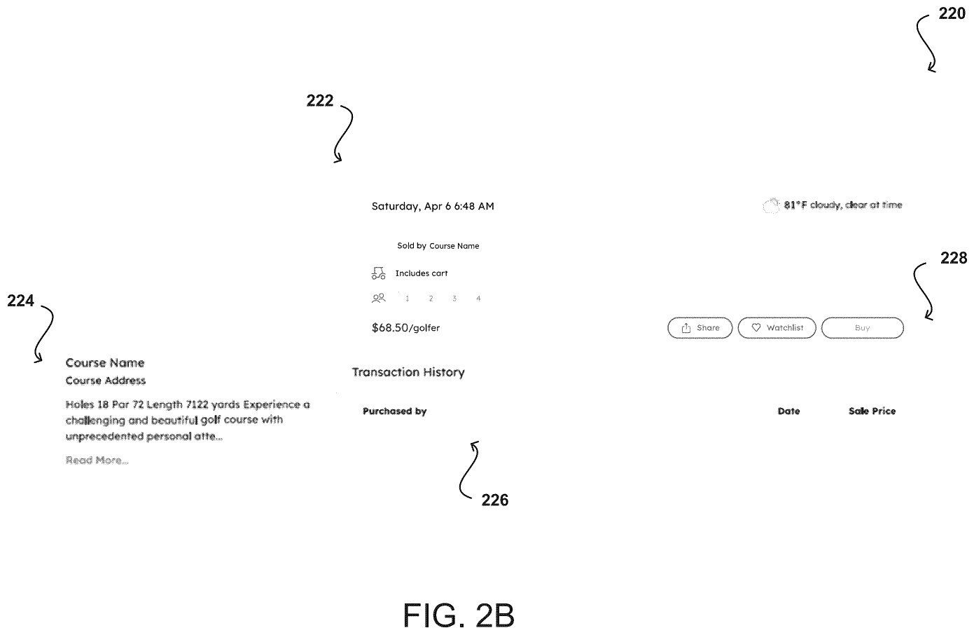

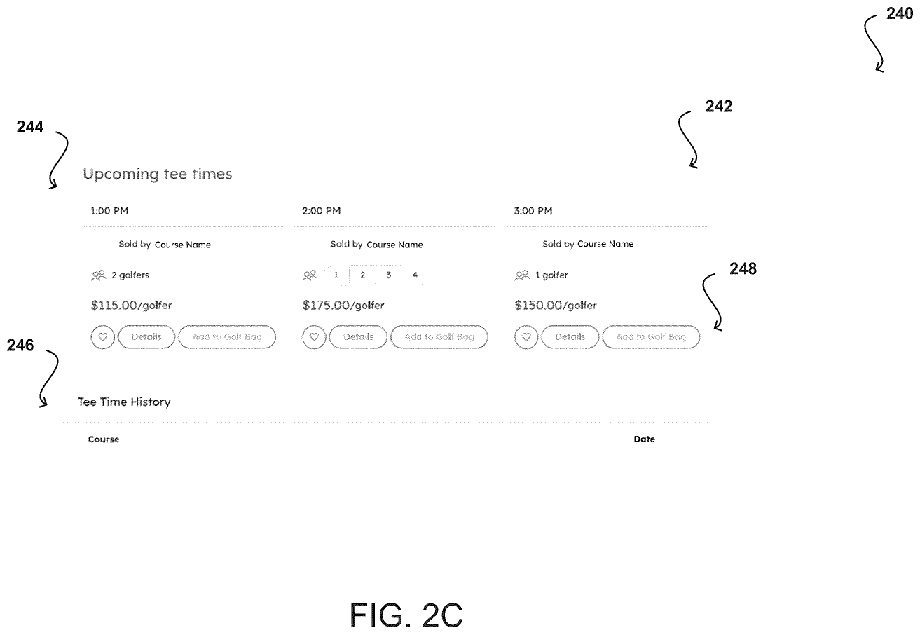

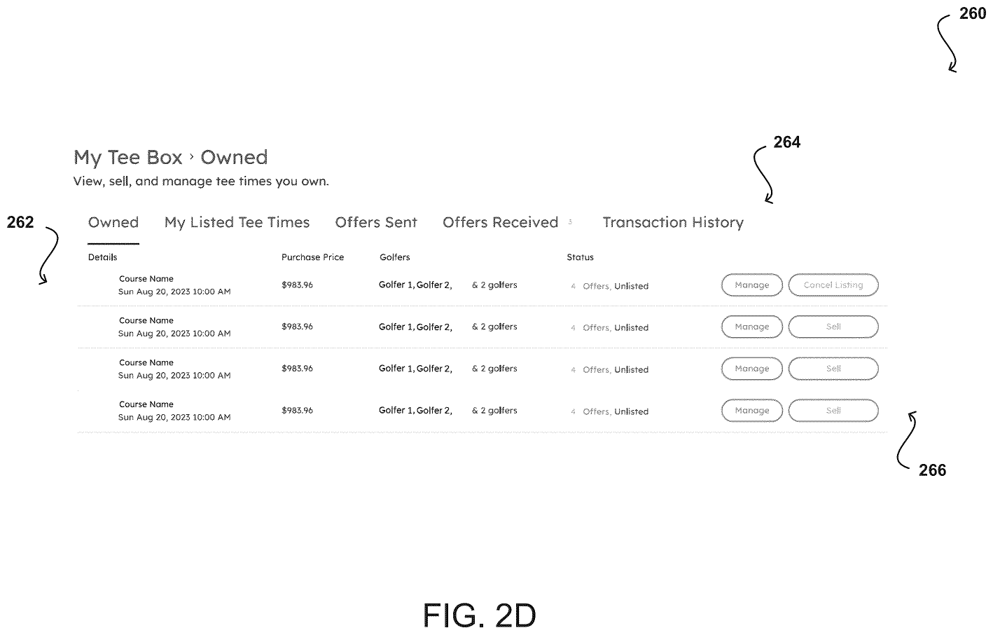

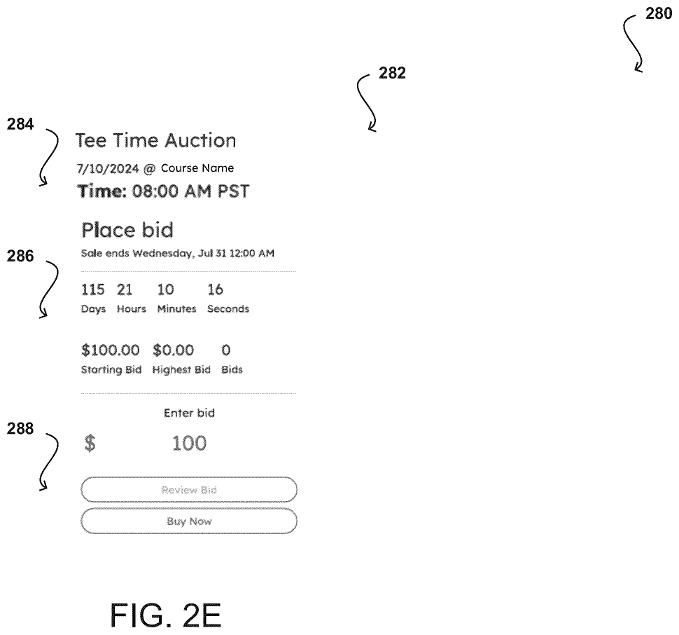

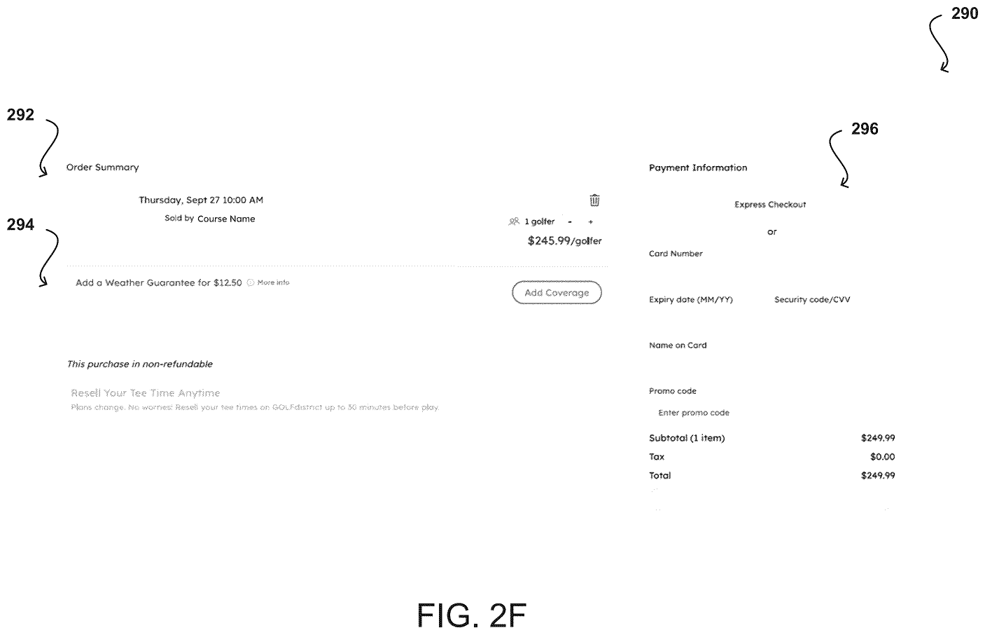

FIG. 2A illustrates an example display 200 of content wherein the content includes reservations 202, such as tee times, from an inventory of reservations that may be offered for consumption through an electronic marketplace. In an embodiment, the content may include reservations 202 of multiple types, ownership, availability, price, locations, industry, or other categorizations. In another embodiment, the displayed reservations 202 may be related by sharing one or more characteristics, such as including tee times, being located at the same venue, being offered by the same owner, such as a golf course or group of related golf courses, or the like. In an embodiment, an application or group of applications may provide services for electronic marketplaces that each provide the reservations 202 to users, such as through the display 200. In another embodiment, a website or other source may direct users to the current content to find the reservations 202. As is illustrated, the reservations 202 may be displayed whether or not they are listed for sale. In this example, the reservations 202 may be owned by a course, a user that may be represented by a profile, or other suitable representation of ownership. In another embodiment, websites or applications associated with individual golf courses may provide access or information to a master course directory. The information shared between the websites or applications may be collected, analyzed, reviewed, managed, processed, or the like.

The content of display 200 may also include functions for users to interact with relevant information. One function may include the ability to sort 204 the reservations 202, such as by time, price, number of participants, or other suitable characteristics. One function may include the ability to filter 206 the reservations 202, such as by start time, whether specific features are included or excluded, the availability status, the number of participants, price range, or other suitable characteristics. One function may include the ability to designate 208 specific information for one or more reservations 202. For example, a user may save or “favorite” reservations 202 to be more easily referenced, such as adding the related reservation to a watchlist, a cart, a golf bag with a similar function, or otherwise associated with a user profile. One function may include the ability to designate 208 that additional details should be provided for reservations 202. In yet another example, a user may designate 208 that reservations 202 should be purchased. Other suitable functions may also be included.

FIG. 2B illustrates an example display 220 of content wherein the content includes reservation details 222, such as tee time details, of a reservation that may be offered for consumption through an electronic marketplace. The reservation details 222 may include information related to individual reservations or groups of reservations. The reservation details 222 may include time, date, location, number of attendees, price, purchase history, predicted weather at the time and location of the reservation, and other relevant information. Users may be able to access or view the reservation details 222 related to individual reservations or groups of reservations. The content of display 220 may also include venue data 224, such as name, location, and other information associated with the venue for reservations. In an example, the venue may be a golf course, and information may include the address, number of holes, par, and course length, or other information. The content of display 220 may also include transaction data 226 for reservations associated with the reservation details 222. The transaction data 226 may include transactions history for reservations associated with the reservation details 222. For each transaction, the transaction data 226 may include a listing of who purchased the reservation, the date of purchase, the sale price, and other relevant information.

The content of display 220 may also include functions for users to interact with reservations associated with the reservation details 222. In an embodiment, a function may allow users to designate 228 information to share reservation details 222 or reservations associated with the reservation details 222. Users may be able to share using suitable communication methods, such as email, text, or a messaging system associated with the electronic market. In an embodiment, a function may allow users to designate 226 information to save or “favorite” reservations to be more easily referenced, such as adding the related reservation to a watchlist, a cart, a golf bag with a similar function, or otherwise associated with a user profile. In an embodiment, a function may allow users to designate 228 information to complete a purchase of a reservation associated to the reservation details 222, such a selecting a link to buy. When purchasing a reservation, the user may be able to select a number of participants that should be included for the reservation, such as three separate golfers that will be in attendance.

FIG. 2C illustrates an example display 240 of content wherein the content includes profile data 242 of a user and associated reservation history that may be offered for consumption through an electronic marketplace. A user may be an individual, a group of individuals, a business, or other entity. In some example, the profile data 242 may be public and able to be seen by certain other users or visitors, or may be specified with some level of privacy to exclude one or more individuals or groups from accessing at least some level of information. In another example, the profile may be connected with payment methods, accounts, or other systems with can be used to make and accept payments. A user may be able to create a profile associated with the profile data 242 by disclosing identifying information, or using other suitable methods. In certain examples, a username to identify the user may be generated or selected by the user. For profiles or accounts that may be original owners of reservations or maintain a partnership with original reservation owners, an administrative profile 242 or account may be maintained. An administrative account may allow the user to manage inventory, access primary market revenue, access secondary market revenue, provide and use analytic tools, and other functionality.

The profile data 242 may include information related to the user and reservations associated with the user, such as upcoming tee time reservations 244, past tee time reservations 246, and information related to those tee times. The upcoming tee time reservations 244 associated with the profile data 242 may include one or more of venue name, reservation date, time, location, previous seller, number of participants, price, or other information. The past tec time reservations 246 associated with the profile data 242 may be included as a tee time history. The past tee time reservations 246 may include one or more of the venue name, reservation date, time, location, previous seller, number of participants, price, or other information.

The content of display 240 may also include functions for users to interact with relevant information. One function may include the ability to designate 248 specific information for one or more reservations. For example, a user may save or “favorite” reservations to be more easily referenced, such as adding the related reservation to a watchlist, a cart, a golf bag with a similar function, or otherwise associated with a user profile. One function may include the ability to designate 248 that additional details should be provided for reservations 242. Other suitable functions may also be included.

FIG. 2D illustrates an example display 260 of content wherein the content includes categorized transactions 262 for reservations associated with a user or user profile that may be offered for consumption through an electronic marketplace. The categorized transactions 262 may be presented for viewing or collected in a location, such as “My Tee Box,” available to users. The categorized transactions 262 may be grouped in categories 264. The categories 264 may include owned reservations, owned reservations listed for sale, offers sent for reservations not listed, offers received for owned reservations, transaction history, and other categories.

The content of display 260 may also include functions for users to interact with relevant information associated with the categorized transactions 262. One function may include the ability to designate 266 a reservation to be offered for sale that is currently owned by selecting the reservation, setting a desired price, and then paying a service fee. One function may include the ability to designate 266, for outstanding offers received from other users for currently owned reservations, making counteroffers, set reserve prices, set criteria to sell automatically, without review, accept, decline, or other actions. Other functions may include the ability to designate 266 information related to categorized transactions 262 to be managed. In another embodiment, a user may be provided recommendations, such as for available reservations, based on information associated with the user.

FIG. 2E illustrates an example display 280 of content wherein the content includes reservation auction 282 for reservations that may be offered for consumption through an electronic marketplace. In an embodiment, the reservation auction 282 may include reservation information 284 relevant to the reservations being offered for sale, auction information 286 associated with the auction, and other information. The reservation information 284 relevant to the reservations may include the reservation date, time, location, venue name, and the like. The auction information 286 relevant to the reservations may include the auction name, end date, end time, time remaining for the auctions, starting bid price, highest bid price, number of bids, and the like.

The content of display 280 may also include functions for users to interact with relevant information associated with the reservation auction 282. One function may include the ability to designate 288 information to enter an bid amount and place a bid for the reservation associated with the auction. One function may include the ability to designate 288 information to review a bid for the reservation associated with the auction before placing the bid. One function may include the ability to designate 288 information to buy now, or purchase outright immediately, the reservation associated with the auction.

FIG. 2F illustrates an example display 290 of content wherein the content includes transaction details 292 of a reservation that may be offered for consumption through an electronic marketplace. The transaction details 292 may include information, such as the venue name, reservation date, time, location, number of participants, price, or other information In an embodiment, the transaction details 292 may be able to be edited by a user, such as changing the payment method, changing the number of participants, the names to be listed on the reservation, and the like. In some embodiments, additional transactions 294 may be added to the transaction. The additional transactions 294 may include insurance, services, guarantees, merchandise, and the like. For example, weather coverage, weather guarantees, or weather insurance may be added in case the reservation may be rendered unusable due to weather and an insurance payout may be made. In some embodiments, reservations may be non-refundable. Payment information 296 for the transaction details 292 may also be included or available to be entered by a user. The payment information 296 may include the ability to use express checkout, such as using payment information associate with the user or user profile, or provide a specific payment data, such as credit card information.

The content of display 290 may also include functions for users to interact with relevant information associated with the transaction details 292. One function may include the ability to designate 288 information to remove or delete a reservation or transaction from the transaction details 292. One function may include the ability to designate 288 information to add the additional transactions 294 to the transaction details 292. One function may include the ability to designate 288 information to buy now or confirm the purchase of the transactions or reservations included in the transaction details 292.

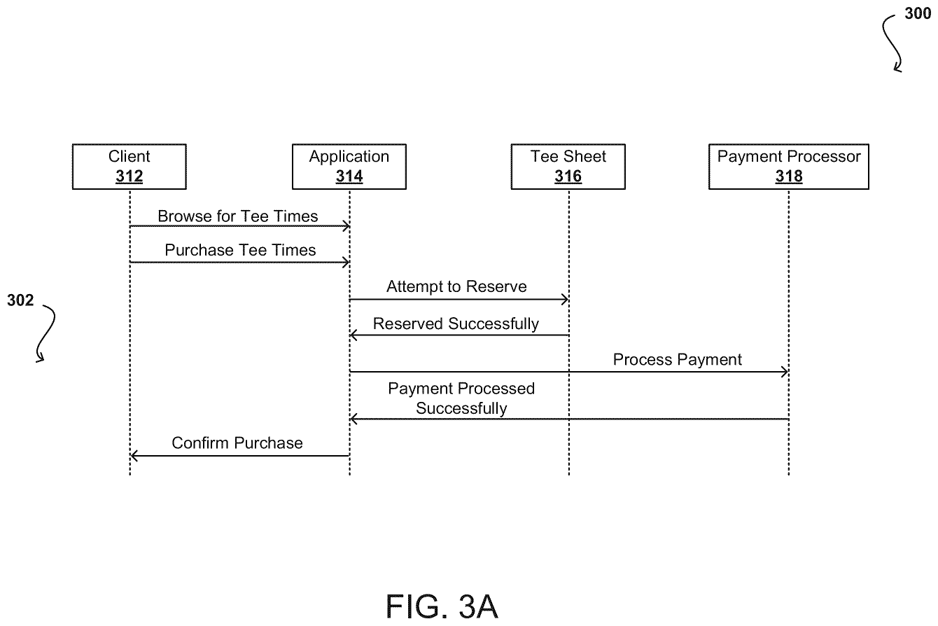

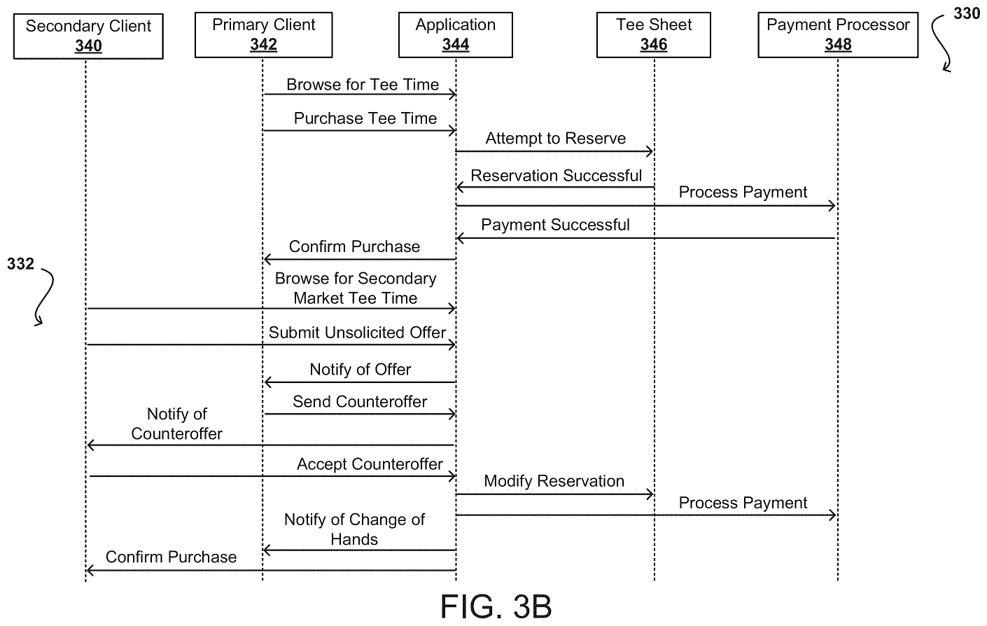

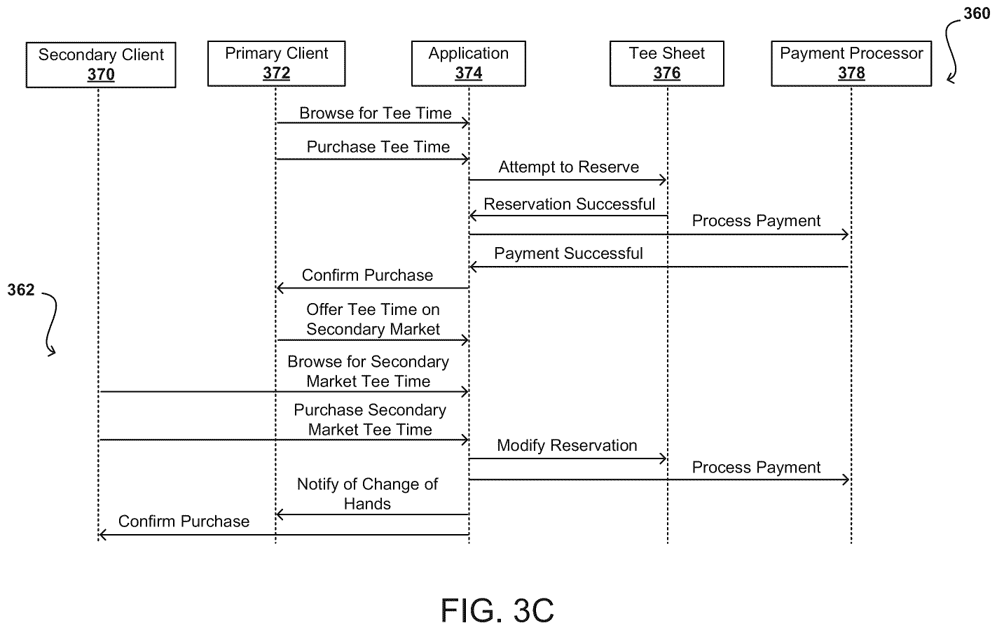

FIG. 3A is a schematic representation 300 of a primary market transaction where a set of transactions steps 302 is illustrated for completing a transaction related to activity times slots, specifically, purchasing a tee time slot. While the illustrated configuration, and other illustrated configurations, may be associated with the steps 302, embodiments of the present disclosure are not limited to steps and may include other processes, such as programs and the like. Primary market transactions may include transactions related to purchasing and selling openly available inventory items, where openly available items can be purchased. In an example, during a primary market transaction available tee times may be selected to be purchased. Users may purchase tee times different numbers of rounds, such as from one or two and up to four or five, which may depend on the individual slot or the course of the tee time. When these tee times are purchased, the transaction may be marked as complete, and the tee sheet contacted and updated with the proper reservation details.

In this example, the set of transaction steps 302 to purchase a tee time slot may be completed using a client device 312, an application 314, a tee sheet 316, and a payment processor 318. In this example, the client device 312 may be used to browse for tee times from the application 314. The client device 312 may then be used to purchase tee times via the application 314. The application 314 may then attempt to reserve the tee time by contacting the tee sheet 316. The tee sheet 316 may be used to determine that the reservation is completed successfully, which is communicated to the application 314. Then, the application 314 may request the payment for the reservation to be processed by the payment processor 318, which can indicate to the application 314 whether or not the payment is processed successfully. Upon successful payment, the application 314 can provide conformation of the completed transaction to the client device 312.

FIG. 3B is a schematic representation 330 of a secondary market transaction where a set of transactions steps 332 is illustrated for completing a transaction related to tee times slots, specifically, making an unsolicited offer for a tee time slot. Secondary market transactions may include transactions related to purchasing and selling available inventory items, including at least making unsolicited and solicited offers. In an example, for an unsolicited offer all items included in the inventories available to the application may be selected, whether or not they are available to purchase. Items that were previously purchased and are not available to be resold by the original purchaser may be marked distinctly. Users may make an unsolicited offer on these items, such as tee time reservations or tickets to events. In one embodiment, tee times, or tec time slots or reservations, can be purchased in an application platform or on a third-party platform. If the tee time is purchased on an application platform, the tee time information to be displayed may be already controlled to accept the unsolicited offer. If the tee time was sold in another platform, the application may use tee sheet integrations to retrieve that information. Therefore, tee times may always be available to be presented to a user. In another embodiment, an application may have default floor price limits to avoid offers that are below an acceptable offer value. The limits may apply during the offer time and may be used to promote a higher price. The original purchasers may adjust the limits. In yet another embodiment, when an unsolicited offer is made, an application may communicate with the tee sheet, retrieve the owner information, and send the owner a notification. If the tee time was purchased in the application platform, the notifications may be always sent for the original purchases. When an unsolicited offer is made, an application may send a notification, such as an email, SMS, or the like, to the original purchaser. The original purchaser may have an amount of time to accept, counter the offer, decline the offer, or some other actions. If the offer was accepted the purchaser's payment method may be charged and the golfer information overwritten in the tee sheet. If the offer was countered, the ability to perform an action in response may be passed back to the owner to accept, counter again, or some other actions, which may go in cycle until final acceptance or rejection. If the offer was rejected, there may be no other actions to be performed. The offer may automatically expire when the expiry of the reservation is reached. The offer may automatically expire when a time limit to respond is reached.

In this example, the set of transaction steps 332 to make an unsolicited offer for a tee time slot may be completed using a secondary client device 340, a primary client device 342, an application 344, a tee sheet 346, and a payment processor 348. In this example, first the primary client device 342 may be used to browse for tee times from the application 344. The primary client device 342 may then be used to purchase tee times via the application 344. The application 344 may then attempt to reserve the tee time by contacting the tee sheet 346. The tec sheet 376 may be used to determine that the reservation is completed successfully, which is communicated to the application 344. Then, the application 344 may request the payment for the reservation to be processed by the payment processor 348, which can indicate to the application 344 whether or not the payment is processed successfully. Upon successful payment, the application 344 can provide conformation of the completed transaction to the primary client device 342. The above actions may be performed in generally the same manner as illustrated in FIG. 3A. To perform an unsolicited offer, the secondary client device 340 may be used to browse for tee times from the application 344, including items on the secondary market. The secondary client device 340 may then be used to make an unsolicited offer for tee times via the application 344. The application 344 may notify the primary client device 342, that was used to for the initial purchase, of the unsolicited offer. The primary client device 342 may then send a counteroffer to the application 344, which the application 344 may then use to notify the secondary client device 340 of the counteroffer. The secondary client device 340 may then accept the counteroffer via the application 344. The application 344 may then modify the reservation of the tee time in the tee sheet 346. The application 344 may request the payment for the offer to be processed by the payment processor 348. The application 344 may send the primary client device 342 notification of the change of hands, or ownership, of the reservation. The application 344 may send the secondary client device 340 notification of the confirmation of the purchase of the reservation.

FIG. 3C is a schematic representation 360 of a secondary market transaction where a set of transactions steps 362 is illustrated for completing a transaction related to tee times slots, specifically, making a solicited offer for a tee time slot. In an example, for a solicited offer a reservation holder, such as a user that purchased a tee time, may make their purchased item available in the application platform to be sold. Inventory items, such as tee times, may be purchased in application platform or on a third-party platform. With a solicited offer, a tee time owner can make the entirety of their tee time rounds or a sub-set of their rounds to be available for sale. If the tee time was purchased in the application, the original purchaser information may already be controlled and the reservation in the tee sheet can be changed. If the tee time was not purchased in the application, the golfer may need to manually enter information into the application platform and confirm that their ownership of that tee time. When the application is used to sell a tee time that was not purchased in the application platform, the ownership status may be able to be changed using the application or another service may change the ownership, such as a customer service representative or an automatic electronic solution. In some embodiments, a secondary purchasers may be able to complete solicited offer transactions.

In this example, the set of transaction steps 362 to make a solicited offer for a tee time slot may be completed using a secondary client device 370, a primary client device 372, an application 374, a tee sheet 376, and a payment processor 378. In this example, first the primary client device 372 may be used to browse for tee times from the application 374. The primary client device 372 may then be used to purchase tee times via the application 374. The application 374 may then attempt to reserve the tee time by contacting the tee sheet 376. The tec sheet 376 may be used to determine that the reservation is completed successfully, which is communicated to the application 374. Then, the application 374 may request the payment for the reservation to be processed by the payment processor 378, which can indicate to the application 374 whether or not the payment is processed successfully. Upon successful payment, the application 374 can provide conformation of the completed transaction to the primary client device 372. The above actions may be performed in generally the same manner as illustrated in FIG. 3A. To perform an solicited offer, the primary client device 372 may be used to place their tee times for sale in the secondary market on the application 344. The secondary client device 370 may then be used to browse for tee times from the application 374, including the secondary market. The secondary client device 370 may then be used to purchase secondary market tec times via the application 374. The application 374 may then modify the reservation of the tec time in the tee sheet 376. The application 374 may request the payment for the reservation to be processed by the payment processor 378. The application 374 may send the primary client device 372 notification of the change of hands, or ownership, of the reservation. The application 374 may send the secondary client device 370 notification of the confirmation of the purchase of the reservation.

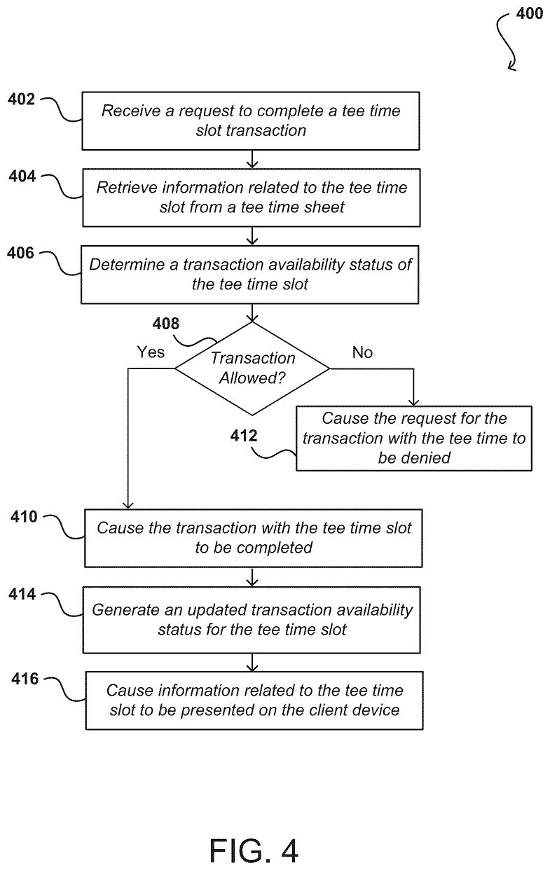

FIG. 4 illustrates an example process 400 for completing transactions associated with scheduled activities or events, such as tee times, which can be utilized in accordance with various embodiments. Although this figure, as well as any other process illustrations contained in this disclosure may depict functional operations in a particular sequence, the processes are not necessarily limited to the particular order or operations illustrated. One skilled in the art will appreciate that the various operations portrayed in this or other figures can be changed, rearranged, performed in parallel or adapted in various ways. Furthermore, it is to be understood that certain operations or sequences of operations can be added to or omitted from the process, without departing from the scope of the various embodiments. In addition, the process illustrations contained herein are intended to demonstrate an idea of the process flow to one of ordinary skill in the art, rather than specifying the actual sequences of code execution, which may be implemented as different flows or sequences, optimized for performance, or otherwise modified in various ways.

In this example, a request is received 402 to complete a tee time slot transaction. The request may be submitted by a suitable user, such as an individual user or customer, a provider on behalf of a customer, a reseller, such as a third-party business, or other suitable user. The request may be received from an interface, such as a website or application, and may be processed using one or more networks. The transactions may be buying, listing, selling, auctioning, and the like. Information related to the tee time may be retrieved 404 from a tee time sheet. The information related to the tee time may include a transaction availability status. The transaction availability status may include at least the current ownership of the time slot and the allowable transactions for the time slot. The tee time sheet may be associated with tee sheet providers. The tee sheet may be used as an inventory management system. A transaction availability status of the tee time slot may be determined 406. The transaction availability status may be recorded, such as in a tee sheet or as an electronic token created by blockchain technology. The transaction availability status may be dependent on one or more factors or conditions.

The transaction allowability 408 for the tee time slot can be determined to be either yes or no. The allowability of the transaction may be determined by any suitable method. The allowability of the transaction may depend at least in part on the transaction availability status. If the transaction is allowable, the transaction with the tee time slot may be caused 410 to be completed. A payment may be processed before, during, or after the transaction is completed. If the transaction is not allowed, the request for the transaction with the tee time slot may be caused 412 to be denied. If the transaction is not allowable, a notification may be sent indicating that the transaction was caused to be denied. An updated transaction availability status may be generated 414 for the tee time slot. The updated transaction availability status may be updated in the tee time sheet. The updated transaction availability status may include at least one of the updated current ownership or the allowable transactions. Information related to the tee time slot may be caused to be presented 416 on the client device. The presented information may include one or more of the updated transaction availability status, the updated current ownership or the allowable transactions. The presented information may also include a notification that the transaction was caused to be completed.

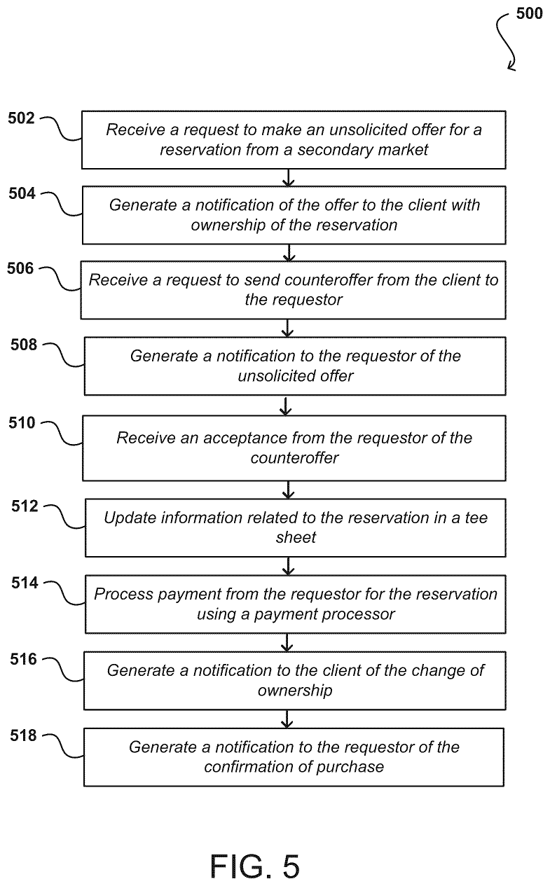

FIG. 5 illustrates an example process 500 for making an unsolicited offer for activity times, that can be utilized in accordance with various embodiments. In this example, a request is received 502 to make an unsolicited offer for a reservation from a secondary market. The request may be received through an electronic device using an application or webpage. The unsolicited offer may be sent by a first client, the requestor, for a reservation controlled or owned by a second client, the owner. A check of the availability status of the reservation may be completed before processing the request. A notification to the client with ownership of the reservation may be generated 504. The notification may be sent using a suitable format, such as a notification in the application or webpage, or through email or other messaging system. The notification may include information related to the request, such as the specific reservation, an offer purchase price, the time of the reservation, the location of the reservation, or other relevant information. A request may be received 506 to send a counteroffer from the client to the requestor. The request to send a counteroffer may be generated automatically or based on the input from the client. The counteroffer may include changes to any relevant features of the reservation that may be negotiable or variable, such as the number of participants, the price of the reservation, or the like. A notification may be generated 408 to the requestor of the unsolicited offer. The notification may be generated based on the request to send a counteroffer. The notification may be sent using a suitable format, such as a notification in the application or webpage, or through email or other messaging system. An acceptance of the counteroffer may be received 510 from the requestor. The acceptance of the counteroffer may be generated automatically or based on the input from the client.

Information related to the reservation may be updated 512 in a tee sheet. The information may be updated in the tee sheet based on the acceptance of the counteroffer. The update of the information may be completed automatically upon acceptance of an offer. The tec sheet may be stored on the same network as the network that that processes the offers, or on a network separate from the network that processes the offers. The sheet may be updated at least in part using an API. The information may be updated using blockchain technology. Payment for the reservation may be processed 514 from the requestor using a payment processor. The payment processing may be completed automatically upon acceptance of an offer. The payment processing may be performed on the same network as the network that that processes the offers, or on a network separate from the network that processes the offers. If the payment cannot be processed, a notification may be sent to the requestor and the owner that the transaction cannot be completed. If the payment cannot be processed, the information related to the reservation may not be updated. A notification may be generated 516 to the client of the confirmation of the purchase or the change of ownership. The generation of the notification to the client may be completed automatically upon successful processing of the payment. The notification may be sent using a suitable format, such as a notification in the application or webpage, or through email or other messaging system. A notification may be generated 518 to the requestor of the confirmation of the purchase or the change of ownership. The generation of the notification to the requestor may be completed automatically upon successful processing of the payment. The notification may be sent using a suitable format, such as a notification in the application or webpage, or through email or other messaging system. An acknowledgement of entry of the change of ownership in the tee sheet may be sent to the client or the requestor as a notification. The generation of the notification for the acknowledgement of entry of the change of ownership in the tee sheet may be completed automatically upon successful processing of the payment. The notification may be sent using a suitable format, such as a notification in the application or webpage, or through email or other messaging system. The notification of entry of the change of ownership in the tee sheet may be sent if payment for the reservation is not completed using the payment processor. If payment for the reservation is not completed using the payment processor, the payment may be completed manually.

One or more waitlist technologies may be incorporated to manage and complete transactions associated with activity times. The wait list technologies may include waitlist management software, virtual waitlists, appointment scheduling, event registration, queue management, waitlist applications, messaging, analytics, and the like. For example, in addition to, or instead of, competing another transaction for an activity time, the user may be join a waitlist for the activity time, such as via an application or computing device. Waitlist data for activity times may be stored in a database and/or activity time sheet that indicates status of each activity time, such as number of users waitlisted, available, sold, reserved, available participants, and the like. The waitlist may be accessed online, for example, by one or more computing devices, and a corresponding waitlist display may be presented to users. Waitlist functionality may be available to enable users to add themselves to a waitlist of an activity time or other offering. Ordering functionality may be available to enable user to complete another transactions, such as purchasing an activity time or other offering. In an example, the waitlist functionality and the ordering functionality may be associated with the same or different transaction, purchase, or checkout applications. In an example, the waitlist functionality and the ordering functionality may be associated with the same or different markets or vendors.

One or more neural networks may be employed to develop a trained model for managing and completing transactions associated with activity times, including proposing prices for activity times, recommending activity times to users, suggesting additional services, determining information for activity times, and the like. For example, activity times associated with user profile data for users that purchased the activity time may be provided to a neural network, along with one or more activity times rejected by the users. The neural network may evaluate the activity times and be trained to select those activity times which would likely be purchased by the users. Thus, once trained with information regarding an activity times and users who would purchase the activity time, the neural network can apply one or more models to determine additional activity times that would appeal to the users. Once evaluated, activity times and likely purchasers or associated profile data may be stored in an evaluation database for further analysis.

As noted, neural network, deep learning, artificial intelligence, and other machine learning techniques have applications for present purposes. As is known in the neural network and artificial intelligence arts, a variety of neural network types could be applied, including, but by no means limited to, feedforward, recurrent, modular, and self-organizing neural networks. Prior to production environment use, a non-production sample data set of typical activity time content may be employed for training a neural network model for processing and analysis of activity times. Metrics, derived through machine learning, may assist the present systems and methods in tracking and understanding patterns in activity times. Although graphics processing units (“GPUs”) are effective for many deep learning neural network applications, the present systems and methods can be used with GPU-based or central processing unit (“CPU”)-based systems.

More particularly, with the emergence of the deep convolutional neural network (“CNN”), a programming and information processing paradigm allowing a machine to learn from data, object detection performance has improved significantly. CNNs are a family of statistical learning models used in machine learning applications to estimate or approximate functions which depend on a large number of inputs. The various inputs are interconnected with the connections having numeric weights that can be tuned over time, enabling the networks to be capable of “learning” based on additional information. Different layers of the network can be composed for different purposes. There is an input layer, which along with a set of adjacent layers, forms the convolution portion of the network. The bottom layer of the convolution layer, along with a lower layer and an output layer, makes up the fully-connected portion of the network. A number of output values can be determined from the output layer, which can include several items determined to be related to an input item, among other such options.

Any type of neural network employed in connection with the present disclosure will likely need adjusting and/or additional or alternative elements to fit the specifics of particular situations. In certain embodiments, training a CNN may involve significant use of computation resources and time, such that this may correspond to a preparatory step to servicing content display requests and/or performed relatively infrequently with respect to request servicing and/or according to a schedule. As known in the object-oriented and other computer science arts, the machine learning features hereunder may be accomplished through the use of separate software modules executing on top of a feature map.

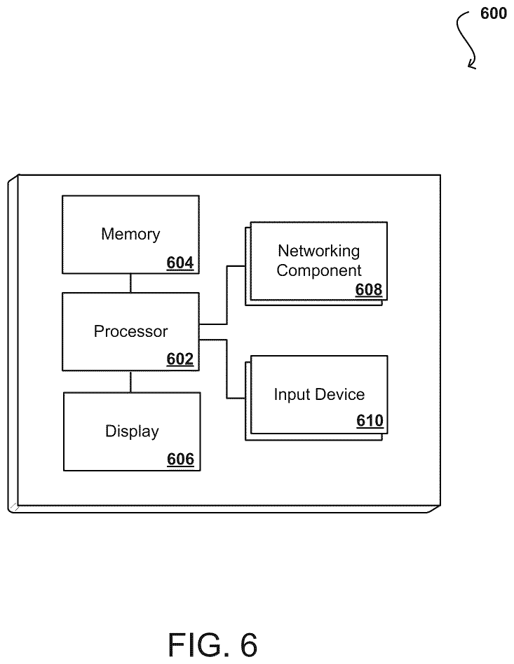

FIG. 6 illustrates a logical arrangement of a set of general components of an example computing device 600. In this example, the device includes a processor 602 for executing instructions that can be stored in a memory device or element 604. As would be apparent to one of ordinary skill in the art, the device can include many types of memory, data storage, or non-transitory computer-readable storage media, such as a first data storage for program instructions for execution by the processor 602, a separate storage for images or data, a removable memory for sharing information with other devices, etc. The device typically will include some type of display element 606, such as a touch screen or liquid crystal display (LCD), although devices such as portable media players might convey information via other means, such as through audio speakers. As discussed, the device in many embodiments will include at least one input element 608 able to receive conventional input from a user. This conventional input can include, for example, a push button, touch pad, touch screen, wheel, joystick, keyboard, mouse, keypad, or any other such device or element whereby a user can input a command to the device. In some embodiments, however, such a device might not include any buttons at all, and might be controlled only through a combination of visual and audio commands, such that a user can control the device without having to be in contact with the device. In some embodiments, the computing device 600 of FIG. 6 can include one or more network interface elements 610 for communicating over various networks, such as a Wi-Fi, Bluetooth, RF, wired, or wireless communication systems. The device in many embodiments can communicate with a network, such as the Internet, and may be able to communicate with other such devices.

As discussed, different approaches can be implemented in various environments in accordance with the described embodiments. As will be appreciated, although a Web-based environment is used for purposes of explanation in several examples presented herein, different environments may be used, as appropriate, to implement various embodiments. The system includes an electronic client device, which can include any appropriate device operable to send and receive requests, messages or information over an appropriate network and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server for receiving requests and serving content in response thereto, although for other networks, an alternative device serving a similar purpose could be used, as would be apparent to one of ordinary skill in the art.

The illustrative environment includes at least one application server and a data store. It should be understood that there can be several application servers, layers or other elements, processes or components, which may be chained or otherwise configured, which can interact to perform tasks such as obtaining data from an appropriate data store. As used herein, the term “data store” refers to any device or combination of devices capable of storing, accessing and retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server in the form of HTML, XML or another appropriate structured language in this example. The handling of all requests and responses, as well as the delivery of content between the client device and the application server, can be handled by the Web server. It should be understood that the Web and application servers are not required and are merely example components, as structured code discussed herein can be executed on any appropriate device or host machine as discussed elsewhere herein.

The data store can include several separate data tables, databases or other data storage mechanisms and media for storing data relating to a particular aspect. For example, the data store illustrated includes mechanisms for storing content (e.g., production data) and user information, which can be used to serve content for the production side. The data store is also shown to include a mechanism for storing log or session data. It should be understood that there can be many other aspects that may need to be stored in the data store, such as page image information and access rights information, which can be stored in any of the above listed mechanisms as appropriate or in additional mechanisms in the data store. The data store is operable, through logic associated therewith, to receive instructions from the application server and obtain, update or otherwise process data in response thereto. In one example, a user might submit a search request for a certain type of item. In this case, the data store might access the user information to verify the identity of the user and can access the catalog detail information to obtain information about items of that type. The information can then be returned to the user, such as in a results listing on a Web page that the user is able to view via a browser on the user device. Information for a particular item of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated. Thus, the depiction of the systems herein should be taken as being illustrative in nature and not limiting to the scope of the disclosure.

The various embodiments can be further implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, FTP, UPnP, NFS, and CIFS. The network can be, for example, a local area network, a wide-area network, a virtual private network, the Internet, an intranet, an extranet, a public switched telephone network, an infrared network, a wireless network and any combination thereof.

In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Perl, Python or TCL, as well as combinations thereof. The server(s) may also include database servers, including without limitation those commercially available from Oracle®, Microsoft®, Sybase® and IBM® as well as open-source servers such as MySQL, Postgres, SQLite, MongoDB, and any other server capable of storing, retrieving and accessing structured or unstructured data. Database servers may include table-based servers, document-based servers, unstructured servers, relational servers, non-relational servers or combinations of these and/or other database servers.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, magnetic tape drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments.

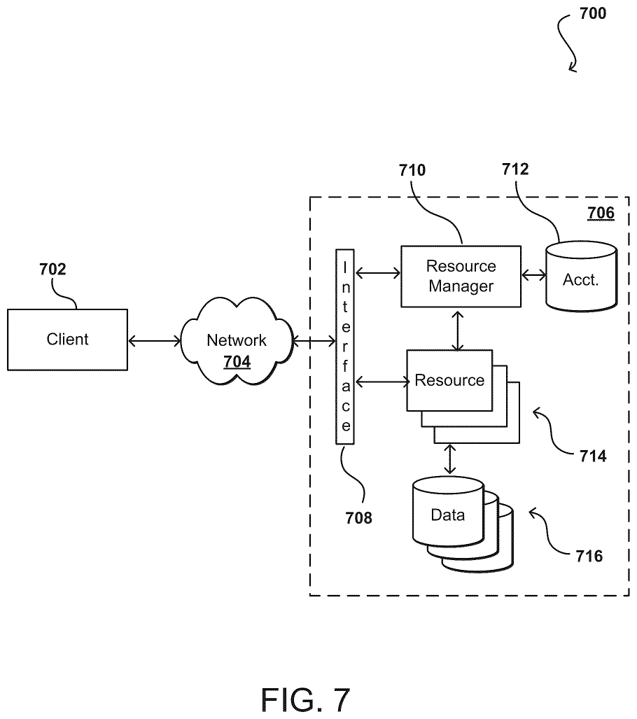

FIG. 7 illustrates an example environment 700 in which aspects of the various embodiments can be implemented. In this example a user is able to utilize a client device 702 to submit requests across at least one network 704 to a resource provider environment 706. The client device can include any appropriate electronic device operable to send and receive requests, messages, or other such information over an appropriate network and convey information back to a user of the device. Examples of such client devices include personal computers, tablet computers, smart phones, notebook computers, and the like. The network 704 can include any appropriate network, including an intranet, the Internet, a cellular network, a local area network (LAN), or any other such network or combination, and communication over the network can be enabled via wired and/or wireless connections. The resource provider environment 706 can include any appropriate components for receiving requests and returning information or performing actions in response to those requests. As an example, the provider environment might include Web servers and/or application servers for receiving and processing requests, then returning data, Web pages, video, audio, or other such content or information in response to the request.

In various embodiments, the provider environment may include various types of electronic resources that can be utilized by multiple users for a variety of different purposes. In at least some embodiments, all or a portion of a given resource or set of resources might be allocated to a particular user or allocated for a particular task, for at least a determined period of time. The sharing of these multi-tenant resources from a provider environment is often referred to as resource sharing, Web services, or “cloud computing,” among other such terms and depending upon the specific environment and/or implementation. In this example the provider environment includes a plurality of electronic resources 714 of one or more types. These types can include, for example, application servers operable to process instructions provided by a user or database servers operable to process data stored in one or more data stores 716 in response to a user request. As known for such purposes, the user can also reserve at least a portion of the data storage in a given data store. Methods for enabling a user to reserve various resources and resource instances are well known in the art, such that detailed description of the entire process, and explanation of all possible components, will not be discussed in detail herein.

In at least some embodiments, a user wanting to utilize a portion of the resources 714 can submit a request that is received to an interface layer 708 of the provider environment 706. The interface layer can include application programming interfaces (APIs) or other exposed interfaces enabling a user to submit requests to the provider environment. The interface layer 708 in this example can also include other components as well, such as at least one Web server, routing components, load balancers, and the like. When a request to provision a resource is received to the interface layer 708, information for the request can be directed to a resource manager 710 or other such system, service, or component configured to manage user accounts and information, resource provisioning and usage, and other such aspects. A resource manager 710 receiving the request can perform tasks such as to authenticate an identity of the user submitting the request, as well as to determine whether that user has an existing account with the resource provider, where the account data may be stored in at least one data store 712 in the provider environment. A user can provide any of various types of credentials in order to authenticate an identity of the user to the provider. These credentials can include, for example, a username and password pair, biometric data, a digital signature, or other such information.

The resource provider can validate this information against information stored for the user. If the user has an account with the appropriate permissions, status, etc., the resource manager can determine whether there are adequate resources available to suit the user's request, and if so can provision the resources or otherwise grant access to the corresponding portion of those resources for use by the user for an amount specified by the request. This amount can include, for example, capacity to process a single request or perform a single task, a specified period of time, or a recurring/renewable period, among other such values. If the user does not have a valid account with the provider, the user account does not enable access to the type of resources specified in the request, or another such reason is preventing the user from obtaining access to such resources, a communication can be sent to the user to enable the user to create or modify an account, or change the resources specified in the request, among other such options.

Once the user is authenticated, the account verified, and the resources allocated, the user can utilize the allocated resource(s) for the specified capacity, amount of data transfer, period of time, or other such value. In at least some embodiments, a user might provide a session token or other such credentials with subsequent requests in order to enable those requests to be processed on that user session. The user can receive a resource identifier, specific address, or other such information that can enable the client device 702 to communicate with an allocated resource without having to communicate with the resource manager 710, at least until such time as a relevant aspect of the user account changes, the user is no longer granted access to the resource, or another such aspect changes.

The resource manager 710 (or another such system or service) in this example can also function as a virtual layer of hardware and software components that handles control functions in addition to management actions, as may include provisioning, scaling, replication, etc. The resource manager can utilize dedicated APIs in the interface layer 708, where each API can be provided to receive requests for at least one specific action to be performed with respect to the data environment, such as to provision, scale, clone, or hibernate an instance. Upon receiving a request to one of the APIs, a Web services portion of the interface layer can parse or otherwise analyze the request to determine the steps or actions needed to act on or process the call. For example, a Web service call might be received that includes a request to create a data repository.

An interface layer 708 in at least one embodiment includes a scalable set of customer-facing servers that can provide the various APIs and return the appropriate responses based on the API specifications. The interface layer also can include at least one API service layer that in one embodiment consists of stateless, replicated servers which process the externally-facing customer APIs. The interface layer can be responsible for Web service front end features such as authenticating customers based on credentials, authorizing the customer, throttling customer requests to the API servers, validating user input, and marshalling or unmarshalling requests and responses. The API layer also can be responsible for reading and writing database configuration data to/from the administration data store, in response to the API calls. In many embodiments, the Web services layer and/or API service layer will be the only externally visible component, or the only component that is visible to, and accessible by, customers of the control service. The servers of the Web services layer can be stateless and scaled horizontally as known in the art. API servers, as well as the persistent data store, can be spread across multiple data centers in a region, for example, such that the servers are resilient to single data center failures.

Other variations are within spirit of present description. Thus, while the described techniques are susceptible to various modifications and alternative constructions, certain illustrated embodiments thereof are shown in drawings and have been described above in detail. It should be understood, however, that there is no intention to limit description to specific form or forms described, but on contrary, intention is to cover all modifications, alternative constructions, and equivalents falling within spirit and scope of description, as defined in appended claims.

Use of terms “a” and “an” and “the” and similar referents in context of describing embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Use of any and all examples, or exemplary language (e.g., “such as”) provided herein, is intended merely to better illuminate embodiments of the description and does not pose a limitation on scope of description unless otherwise claimed. No language in specification should be construed as indicating any non-claimed element as essential to practice of the description.

Although descriptions herein set forth example implementations of described techniques, other architectures may be used to implement described functionality, and are intended to be within scope of this description. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are described as exemplary forms of implementing the claims.

At least one embodiment of the disclosure can be described in view of the following clauses:

1. A computer-implemented method, comprising:
receiving, from a client computing device, a request to complete a transaction with respect to a time slot for performing an activity;
determining a transaction availability status of the time slot, the transaction availability status including at least current ownership and allowable transactions;
causing, based at least in part on the transaction availability status, the transaction with the time slot to be completed;
generating an updated transaction availability status for the time slot; and
causing information related to the time slot, including at least in part the updated transaction availability status, to be presented on a display of the client device.

2. The computer-implemented method of clause 1, wherein the transaction includes an unsolicited offer.

3. The computer-implemented method of clause 1, wherein the time slot comprises a tee time for golf.

4. The computer-implemented method of clause 1, further comprising:
creating a token for the completed transaction for the time slot.

5. The computer-implemented method of clause 4, further comprising:
allow the token to be traded on a secondary market.

6. The computer-implemented method of clause 1, further comprising:
storing the updated transaction availability status for the time slot.

7. The computer-implemented method of clause 1, wherein the transaction includes submitting a bid in an auction for the time slot.

8. The computer-implemented method of clause 1, further comprising:
offering weather insurance for the time slot with the request to complete the transaction.

9. A system comprising:
at least one processor; and
memory including instructions that, when executed by the at least one processor, cause the system to:
   receive, from a client computing device, a request to complete a transaction with respect to a time slot for performing an activity;
   determine a transaction availability status of the time slot, the transaction availability status including at least current ownership and allowable transactions;
   cause, based at least in part on the transaction availability status, the transaction with the time slot to be completed;
   generate an updated transaction availability status for the time slot; and
   cause information related to the time slot, including at least in part the updated transaction availability status, to be presented on a display of the client device.

10. The system of clause 9, wherein the transaction includes an unsolicited offer.

11. The system of clause 9, wherein the time slot comprises a tee time for golf.

12. The system of clause 9, wherein the instructions when executed further cause the system to:
create a token for the completed transaction for the time slot.

13. The system of clause 12, wherein the instructions when executed further cause the system to:
allow the token to be traded on a secondary market.

14. The system of clause 9, wherein the instructions when executed further cause the system to:
store the updated transaction availability status for the time slot.

15. The system of clause 9, wherein the transaction includes submitting a bid in an auction for the time slot.

16. The system of clause 9, wherein the instructions when executed further cause the system to:
offer weather insurance for the time slot with the request to complete the transaction.

17. A computer-implemented method, comprising:
accepting reservations for a plurality of different time slots to perform an activity;
enabling a user to view information for the reservations at the plurality of different time slots; and
enabling the user to make a new reservation at an open time slot or make an offer to purchase an existing reservation for one or more of the different time slots.

18. The computer-implemented method of clause 17, wherein the purchase of one or more of the reservations are recorded.

19. The computer-implemented method of clause 17, further comprising:
confirming acceptance of the offer to purchase; and
providing a notification of the acceptance to the user.

20. The computer-implemented method of clause 17, wherein the user makes the offer to purchase the existing reservation from a secondary market.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A computer-implemented method, comprising:
receiving, from a client computing device, a request to complete a transaction with respect to a time slot for performing an activity;
determining a transaction availability status of the time slot, the transaction availability status including at least current ownership and allowable transactions;
causing, based at least in part on the transaction availability status, the transaction with the time slot to be completed;
generating an updated transaction availability status for the time slot; and
causing information related to the time slot, including at least in part the updated transaction availability status, to be presented on a display of the client device.

2. The computer-implemented method of claim 1, wherein the transaction includes an unsolicited offer.

3. The computer-implemented method of claim 1, wherein the time slot comprises a tee time for golf.

4. The computer-implemented method of claim 1, further comprising:
creating a token for the completed transaction for the time slot.

5. The computer-implemented method of claim 4, further comprising:
allow the token to be traded on a secondary market.

6. The computer-implemented method of claim 1, further comprising:
storing the updated transaction availability status for the time slot.

7. The computer-implemented method of claim 1, wherein the transaction includes submitting a bid in an auction for the time slot.

8. The computer-implemented method of claim 1, further comprising:
offering weather insurance for the time slot with the request to complete the transaction.

9. A system comprising:
at least one processor; and
memory including instructions that, when executed by the at least one processor, cause the system to:
receive, from a client computing device, a request to complete a transaction with respect to a time slot for performing an activity;
determine a transaction availability status of the time slot, the transaction availability status including at least current ownership and allowable transactions;
cause, based at least in part on the transaction availability status, the transaction with the time slot to be completed;
generate an updated transaction availability status for the time slot; and
cause information related to the time slot, including at least in part the updated transaction availability status, to be presented on a display of the client device.

10. The system of claim 9, wherein the transaction includes an unsolicited offer.

11. The system of claim 9, wherein the time slot comprises a tee time for golf.

12. The system of claim 9, wherein the instructions when executed further cause the system to:
create a token for the completed transaction for the time slot.

13. The system of claim 12, wherein the instructions when executed further cause the system to:
allow the token to be traded on a secondary market.

14. The system of claim 9, wherein the instructions when executed further cause the system to:
store the updated transaction availability status for the time slot.

15. The system of claim 9, wherein the transaction includes submitting a bid in an auction for the time slot.

16. The system of claim 9, wherein the instructions when executed further cause the system to:
offer weather insurance for the time slot with the request to complete the transaction.

17. A computer-implemented method, comprising:
accepting reservations for a plurality of different time slots to perform an activity;
enabling a user to view information for the reservations at the plurality of different time slots; and
enabling the user to make a new reservation at an open time slot or make an offer to purchase an existing reservation for one or more of the different time slots.

18. The computer-implemented method of claim 17, wherein the purchase of one or more of the reservations are recorded.

19. The computer-implemented method of claim 17, further comprising:
confirming acceptance of the offer to purchase; and
providing a notification of the acceptance to the user.

20. The computer-implemented method of claim 17, wherein the user makes the offer to purchase the existing reservation from a secondary market.
